(19) United States
(12) Patent Application Publication
(10) Pub. No.: US 2014/0293611 A1
(43) Pub. Date: Oct. 2, 2014

(54) CORNER WALL LAMP HOLDING DEVICE

(71) Applicant: John J. Accornero, South Pasadena, CA (US)

(72) Inventor: John J. Accornero, South Pasadena, CA (US)

(21) Appl. No.: 13/769,269

(22) Filed: Apr. 2, 2013

(51) Int. Cl. F21V 21/02; F21V 7/00

(52) U.S. Cl. CPC F21V 21/02; F21V 7/00
USPC 362/296.01

(57) ABSTRACT

A small portable lamp holding device for corner mounting in wall corners and provides an inner space for the lamp socket, switch, and cord and concealed wiring. The arms of the fixture reflector bracket in the lamp fitting device has holes in the corner angle and holes in the top and bottom left and right hand corners to engage appropriate mechanical fasteners such that the device does not pull away from the wall due to repeated use.

### FIELD OF THE INVENTION

The present invention relates to the field of lamps, particularly to lamp fittings.

More particularly the present invention related to a small portable lamp holding device that can be used for corner mounting.

### BACKGROUND OF THE INVENTION

Uniform lighting throughout the interior and exterior of a building is essential. Lights and lamps are normally fastened onto a flat wall within the room as per the convenience of the user. These lamps are usually placed in the centre of a wall to provide uniform lighting throughout the room. Alternatively lamps are also fitted in the specific areas of the room that require lighting, such as above a writing desk, or a wardrobe.

Corners of a building and corners in a room, where one wall meets another wall, also require to be provided with adequate lighting. Conventionally two separate electrical fittings are provided on outside wall corners, one on one outside wall forming the corner and the other on the other adjoining outside wall forming the corner of a building. Such fittings are used in particular for illumination of the outer walls of the building.

However a major problem faced when lighting corner areas, is that the corner areas of rooms in the interior of a building are usually poorly lighted due to there not being holding devices to fasten a lamp into the 90° angle niche formed by two interconnecting walls.

The relevant prior art methods, which will deal with various kinds of lamp holding devices that can be used for various kinds of mounting, including corner mounting, are as follows:

U.S. Pat. No. 5,349,134 provides for a lighting fixture that has a self-contained triangular junction box that mounts in the corner of a room or space with the box cover secured as a permanent part of the shade-like lamp housing. The lamp housing has a back panel with a cut-out that slips over the corner mounted junction box, the box cover extending into the housing for registration with the open side of the box when the housing is in place. A single screw joins the box cover to the box and thereby secures the lamp housing thereto. An electrical device mounting system employs various adapter structures that mount in the corner of a room and by means of which various junction boxes, or other electrical components, can be fastened in the corner of a room thereto. A series of structures are illustrated for corner mounting of telephone equipment such as jacks, wall mountable instruments, and the like.

U.S. Pat. No. 6,388,345 claims a corner light switch assembly to be mounted against a corner edge of a wall corner at a predetermined location and vertical height. The corner light switch assembly includes 1) a main switch body; 2) a switch body cover plate of L-shape constructed of a transparent plastic material connected to the main switch body; 3) a touch sensitive switch assembly mounted in the main switch body and engageable with the switch body cover plate; and 4) a power supply cord to connect an appliance, table lamp or light fixture to the touch sensitive switch assembly for selective operation thereof The switch body cover plate has a sensor section with a plurality of sensor openings therein. The touch sensitive switch assembly includes a touch plate sensor connected to a touch sensitive switch circuit. The touch plate sensor is placed within one of the sensor openings in the sensor section of the switch body cover plate and having the touch plate sensor mounted therein. The touch sensitive switch circuit is known in the prior art.

U.S. Pat. No. 5,057,980 describes a lighting fixture that has a self-contained triangular junction box that mounts in the corner of a room or space with the box cover secured as a permanent part of the shade-like lamp housing. The lamp housing has a back panel with a cut-out that slips over the corner mounted junction box, the box cover extending into the housing for registration with the open side of the box when the housing is in place. A single screw joins the box cover to the box and thereby secures the lamp housing thereto.

U.S. Pat. No. 4,460,947 discloses a light fixture housing includes upper and lower members. The upper member includes a top bounded on four sides by a wall and the lower member includes a bottom also bounded on four sides by a wall. The walls of the two members define four corners of the housing. At each of the corners in the upper member a tang with an inclined leading ramp is formed on the inner peripheral surface of the wall and is flanked at two sides by a guide. At each of the corners of the lower member and upstanding tongue extends above the wall and includes an aperture for receiving the tang when the upper and lower members are assembled. A slot is located in at least one of the corners of the upper member adjacent to the locking tang and a notch is formed in the upper end of at least one of the tongues such that a power line may be threaded through and held within the slot. To assemble the housing, the upper and lower members are positioned together and each of the tongues is positioned within a set of guides. The upper and lower members are locked together after each tang is positioned within an aperture and, after assembly, the latching mechanism is completely hidden from view.

However the purpose and methodology of all the above inventions that are part of prior art do not envisage the unique embodiment of a small portable lamp holding device that is capable of being attached to a wall corner of more than 90° digress and acting as the reflector, socket, switch, cord, attaching or holding device for the lamp.

Accordingly, improvements are needed in the existing methods and structures that negate the above shortcomings. Thus it is desirable to provide a portable lamp holding device which does not pull away when the human touch is applied, is easily mountable in wall corners and can function as the holding device for the reflector, lamp socket, switch, and cord.

The configuration in the present invention addresses these shortcomings in the prior art by providing a lamp holding device which is more efficient in mounting and stability since the device has fasteners in the top and bottom left and right hand corners of the holding device. The present invention further is a ‘reflector’ that holds the fitting to the wall and a socket/switch fastened to reflector/cord with the plug connected to socket.

The present lamp holding device can be used with different kinds of shades, diffusers and reflectors. The present lamp holding device thus provides high quality indirect and ambient, along with task lighting to an inside corner space of more than 90° angle between the walls forming the corner.

Further it will be apparent to those skilled in the art that the objects of this invention have been achieved by providing a small portable lamp holding device for corner mounting. Various changes may be made in and without departing from the concept of the invention. Further, features of some stages disclosed in this application may be employed with features of other stages. Therefore, the scope of the invention is to be determined by the terminology, and the legal equivalents thereof.

### SUMMARY OF THE INVENTION

This present invention may be summarized, at least in part, with reference to its objects.

The foremost object of the present invention is to provide a novel small portable lamp holding device that can be corner mounted in a 90° wall angle.

Another object of the present invention is to provide a lamp holding device that can be effectively fastened.

Another object of the present invention is to provide a lamp holding device that acts as the holding device for the reflector socket, switch and cord of the lamp.

Another object of the present invention is to provide a lamp holding device that is easily mountable and dismantleable and therefore portable

A further object of the present invention is to provide a lamp holding device which is inexpensive.

As with thousands of stylized lamp shades may be used on this device, any material that can support itself and desirable may be incorporated

Additional objects and embodiments of the invention will be set forth in part in the description which follows, and in part will become apparent to those skilled in the art upon examination of the following, or may be learned by practice of the invention. These and other objects and advantages and features of the present invention will be more readily apparent when considered in reference to the following description and when taken in conjunction below.

### DESCRIPTION OF THE DRAWINGS

FIG. 1 is a perspective view of the reflector bracket of the lamp holding device of the present invention.

FIG. 2 is another perspective view of the reflector bracket of the lamp holding device of the present invention.

FIG. 3 is another perspective view of the reflector bracket of the lamp holding device of the present invention.

FIG. 4 is a flattened view of the reflector bracket of the lamp holding device of the present invention.

FIG. 5 is a flattened view of the reflector bracket of the lamp holding device of the present invention.

FIG. 6 is an overhead view of the mounted reflector bracket of the lamp holding device of the present invention.

FIG. 7 is a flattened view of the reflector arm of the lamp holding device of the present invention.

### DETAILED DESCRIPTION OF THE INVENTION

The following description is presented to enable any person skilled in the art to make and use the invention, and is provided in the context of particular applications of the invention and their requirements. The present invention can be configured as follows:

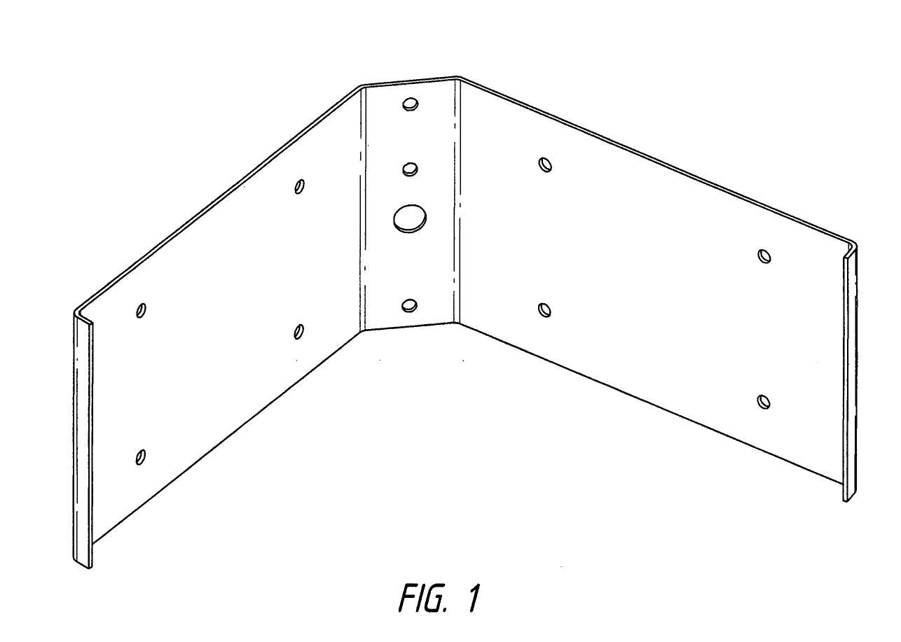

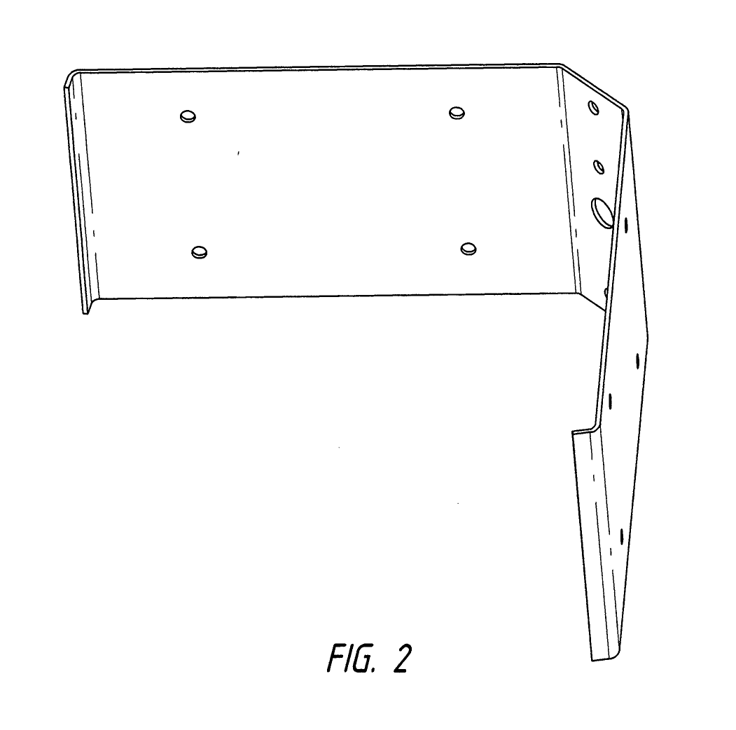

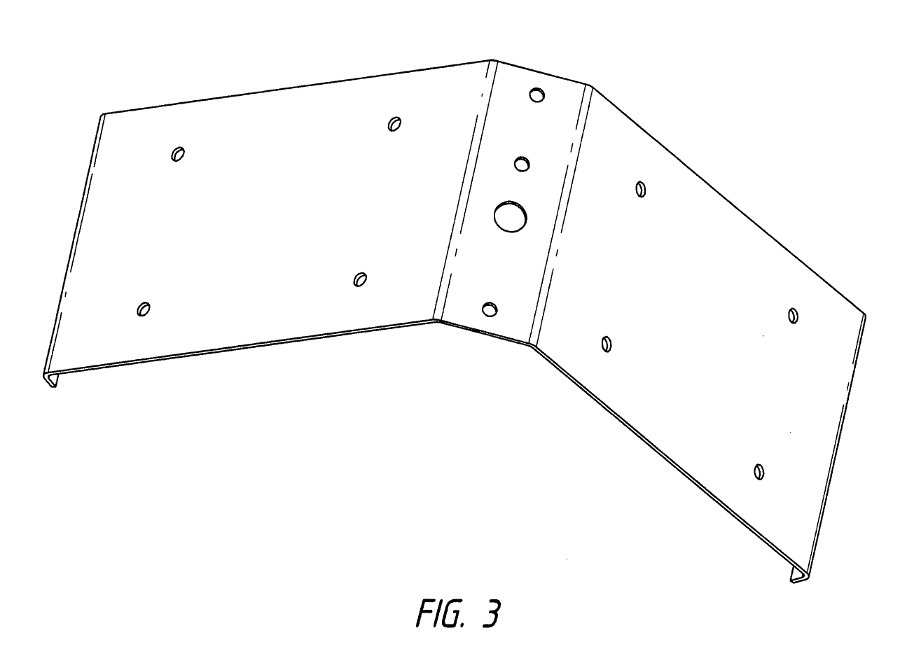

As detailed in FIGS. 1 to 3, the present invention is a novel small portable lamp holding device consisting of a fixture body in the form of a bracket, which is to be fastened inside the triangular 90° corner angle between two meeting walls. This fixture bracket can be made of plastic, metal, wood or injection molded polyplastics. The reflector, socket holder, with cord has two fastening methods, one by attaching 1 fastener in the center fold area, minimum, or by attaching 1 fastener left and right of ‘center fold’ no more than 50% of distance from device center angle. The device can mount to the wall and have hard wire electric power, and is portable with cord.

The cross section of the fixture bracket will reveal a half square the two sides of the square or arms of which are preferably at a 90° angle to each other with a center fold. The arms of the fixture bracket thus abut against the corner walls of a room when fitted to the triangular space at the meeting point of the two walls. The reflector is of a size of 15″×4.50″ or rather proportions, with the center flat of a size of 1.25″ and the left and right bend inward at an angle of 22.5 degrees, and with an end bend of 300″ as needed. The fixture bracket may be located at any convenient distance from the ceiling above the meeting point of the two walls, as per the preferences of the user. The fixture bracket is the reflector as well,

In a preferred embodiment of the present invention, as seen in FIG. 7, each of the fixture bracket arms contains holes at the top and bottom right and left corner for fastening. The invention may be fastened by several methods including mechanical fasteners such as screws or nails. The holes at the top and bottom right and left corner of the fixture bracket can receive the mechanical fasteners which extend substantially parallel to each other and perpendicular to the arms of the fixture bracket. The mechanical fasteners facilitate the anchoring of the fixture bracket to the wall thus fitting the holding device body into the corner meeting point of the two walls. There are two fastening methods, one by attaching 1 fastener in the center fold area, minimum, or two by attaching 1 fastener left and right of the center fold area no more than 50% of distance from the device center angle.

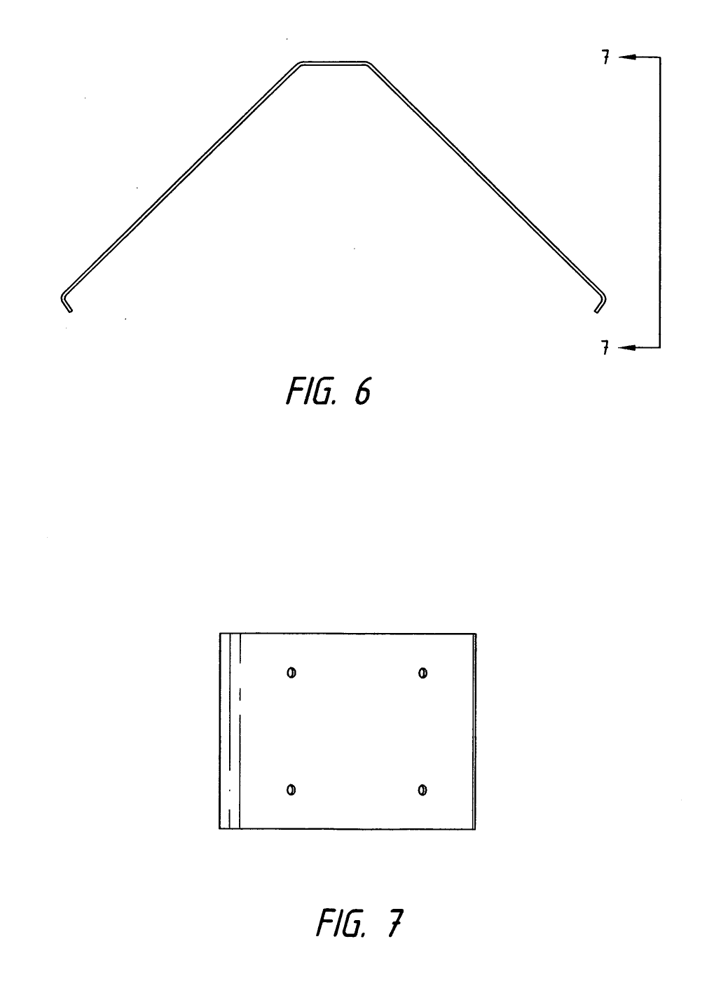

In a preferred embodiment of the present invention, as seen in FIG. 6, the arm of the fixture bracket defines an inner space to accommodate the electrical wiring and the lamp. The middle fold of the fixture bracket where the two arms meet contains a hole for electrical connections, joined to the electrical conduit system inside the building preferably as an electrical lamp socket, and an electrical cord with no exposed wiring. On the front wall of the fixture bracket an electrical appliance such as a lamp may be fitted through screwing into the electrical lamp socket, which then is electrically joined to the electrical connection through the operation of the light plug. The fixture bracket is the reflector as well,

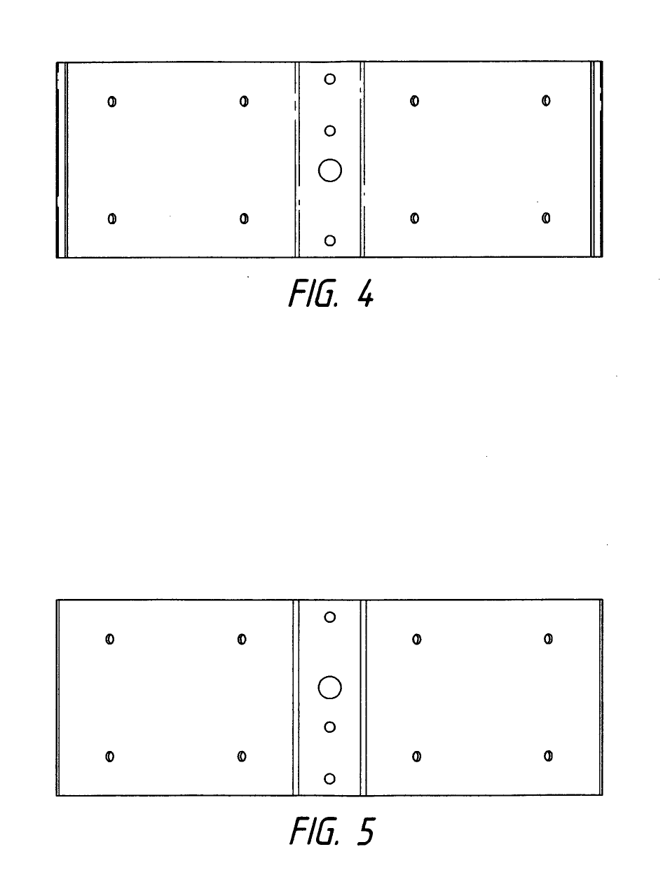

In a preferred embodiment of the present invention, the reflector of the present invention is the lamp holder bracket and accommodates the socket and switch,cord. The reflector has a 4.5×15 ratio with a 1.25 fold. As seen in FIGS. 4 and 5, the reflector that has one large hole at the centre spot in the corner angle, 3 small holes with 2 positioned above and 2 below the large hole all in the corner angle. Other than this, the reflector arms contain 4 holes each at the left and right bottom and top of each arm to enhance the light reflections from the light source. The reflector fixture bracket is thus held to the wall. The electrical lamp socket and a switch are fastened fixedly to the reflector and the electrical cord with the light plug connected to the socket. It is to be understood that the electrical cord will be connected to an appropriate source of electricity, which is not shown.

Therefore, in accordance with the present invention, a small portable lamp holding device for corner mounting is provided which can be attached to a corner angle between two meeting walls in a building and which negates the necessity for two separate light fittings in the conventional manner in each wall for lighting the corner niche between the wall. Thereby considerable savings in costs of producing the light fittings and labor in attaching such light fittings are achieved.

Further it is noted in the art that continuous use of a lamp holding device by engaging a lamp cord tends to result in the holding device disengaging from wall, due to insufficient fastening mechanisms, such as fastening holes only on the top left and right of the holding device. The fixture bracket of the present invention is provided with fastening holes at the left and right top and bottom of the bracket, such that when the user pulls on the cord, the holding device will not pull away from the wall. This ensures the long life of the holding device claimed by the present invention and helps to prevent any untoward accidents. As well two fasteners may be inserted into the middle fold directly into the corner or apex of the perceived triangle wall. Thus there are two ways of attaching to a wall surface.

In this application, the terminology ‘embodiment’ can be used to describe any aspect, feature, process or step, any combination thereof, and/or any portion thereof, etc. While the invention has been described in connection with specific embodiments thereof, it will be understood that it is capable of further modifications and this application is intended to cover any variations, uses or adaptations of the invention following, in general, the principles of the invention and including such departures from the present disclosure come within known or customary practice within the art to which the invention pertains and may be applied to the essential features herein before set forth.

Further it will be apparent to those skilled in the art that the objects of this invention have been achieved by providing the above invention. However various changes may be made in the structure of the invention without departing from the concept of the invention. Therefore, the scope of the invention is to be determined by the terminology of the above description and the legal equivalents thereof.

Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

I claim:

1. A novel lamp holding device for corner mounting comprising:
a fixture body in the form of a reflector bracket which is to be fastened inside the triangular 90° corner angle between two meeting walls;
an electrical lamp socket fastened fixedly to the reflector bracket with a light plug connected to the socket;
an electrical cord fastened fixedly to the reflector bracket with no exposed wiring;
an electrical switch;
an electrical appliance such as a lamp fitted through screwing into the electrical lamp socket, and electrically joined to the electrical connection through the operation of the light plug;
characterized in that the fixture reflector bracket has a 4.5×15 ratio with a 1.25 fold and has two arms perpendicular to and at an 90° angle to each other, each arm abutting against a wall of a room when fitted to the triangular space at the meeting point of the two walls, the arms defining an inner space to accommodate the electrical lamp socket, the electrical cord and the electrical switch.

2. A novel lamp holding device for corner mounting as claimed in claim 1 wherein the middle fold of the fixture reflector bracket where the two arms meet, contains a hole for electrical connections joined to the electrical conduit system inside the building.

3. A novel lamp holding device for corner mounting as claimed in claim 1 wherein one large hole is present at the centre spot in the corner angle, 3 small holes with 2 positioned above and 2 below the large hole all in the corner angle, the arms containing 4 holes each at the left and right bottom and top of each arm to enhance the light reflections from the light source.

4. A novel lamp holding device for corner mounting as claimed in claim 1 wherein the holes at the top and bottom right and left corner of each arm receives mechanical fasteners such as screws or nails which extend substantially parallel to each other and perpendicular to the arms, anchoring of the fixture reflector bracket to the wall.

5. A novel lamp holding device for corner mounting as claimed in claim 1 wherein the fixture reflector bracket may be made of plastic, metal, or injection molded polyplastics.

6. A novel lamp holding device for corner mounting as claimed in claim 1 wherein the fixture reflector bracket is of a size of 15″×4.50″ or rather proportions, with the center flat of a size of 1.25″ and the left and right bend inward at an angle of 22.5 degrees, and with an end bend of 300″ as needed.

7. A novel lamp holding device for corner mounting as claimed in claim 1 and the working thereof wherein there are two fastening methods, one by attaching 1 fastener in the center fold area, minimum, or two by attaching 1 fastener left and right of the center fold area no more than 50% of distance from the device center angle.

8. A novel lamp holding device for corner mounting as claimed in claim 1 and the working thereof wherein on fixing the fixture reflector bracket to the meeting point of the two walls, the light from the lamp strikes the reflector and illuminate the corner area between the walls.
